(19) United States
(12) Patent Application Publication
(10) Pub. No.: US 2019/0130072 A1
(43) Pub. Date: May 2, 2019

(54) VIRTUAL CONSULT RECORD

(71) Applicant: CERNER INNOVATION, INC., Kansas City (KR)

(72) Inventors: DAVID P. MCCALLIE, JR., STILWELL, KS (US); CHRISTOPHER S. FINN, LIBERTY, MO (US); MARGARET CUSHING KOLM, KANSAS CITY, MO (US)

(21) Appl. No.: 15/795,647

(22) Filed: Oct. 27, 2017

(51) Int. Cl. G06F 19/00; G06F 17/30

(52) U.S. Cl. CPC G06F 19/345; G06F 19/322; G06F 17/30684

(57) ABSTRACT

Loosely-structured or unstructured threaded conversations are captured from at least one clinician. Based on a semantic analysis of the loosely-structured or unstructured threaded conversations from the at least one clinician, an issue corresponding to a clinical concern is identified. Upon the at least one virtual consultant accepting an invitation to collaborate on the issue, the at least one virtual consultant is provided the loosely-structured or unstructured threaded conversations from the at least one clinician. The at least one virtual consultant is further enabled to add contributions to the issue.

### BACKGROUND

With the increasing complexity and specialization of medicine, a patient with a rare or complex condition may benefit from the expertise of multiple clinicians with varied background in different disciplines. However, a treating clinician may not know that there exists a clinician with expertise in a specific aspect of the patient's condition, or the identity of such an expert, especially if the expert is outside the clinician's institution or geographic region. If an expert is far away, it is a hardship to the patient to participate in a traditional consult, which requires that the patient travel to the consulting clinician. Even when an outside or remote expert does consult on a patient case, communication between the various clinicians is often incomplete, slow, and inefficient. This can create inconvenience, increase costs, and adversely affect patient care and treatment.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present disclosure relate to systems, methods, and user interfaces that enable consultations between clinicians. More particularly, embodiments of the present disclosure facilitate building threaded consultations with experts for an issue corresponding to a clinical concern. To do so, loosely-structured or unstructured threaded conversations are captured from at least one clinician. Based on a semantic analysis of the loosely-structured or unstructured threaded conversations from at least one clinician, an issue is identified. At least one virtual consultant is identified. Upon at least one virtual consultant accepting an invitation to collaborate on the issue, at least one virtual consultant is provided the loosely-structured or unstructured threaded conversations from at least one clinician. At least one virtual consultant is further enabled to add contributions to the issue.

### BRIEF DESCRIPTION OF THE SEVERAL VIEWS OF THE DRAWINGS

The patent or application file contains at least one drawing executed in color. The present invention is described in detail below with reference to the attached drawing figures, wherein:

FIG. 1 is a block diagram of an exemplary operating environment suitable to implement embodiments of the present invention;

FIG. 2 depicts an exemplary framework of a consultation system suitable to implement embodiments of the present invention;

FIG. 3 depicts a flow diagram of a method for identifying a virtual consultant to collaborate with for a particular issue, in accordance with an embodiment of the present invention; and

FIG. 4 is a flow diagram of a method for identifying a virtual consultant to collaborate with for a particular issue, in accordance with embodiments of the invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

As noted in the Background, with the increasing complexity and specialization of medicine, a patient with a rare or complex condition may benefit from the expertise of multiple clinicians with varied background in different disciplines. However, a treating clinician may not know that there exists a clinician with expertise in a specific aspect of the patient's condition, or the identity of such an expert. This is especially likely if the expert is outside the clinician's institution or geographic region. If an expert is far away, it is a hardship to the patient to participate in a traditional consult, which requires the patient to travel to the consulting clinician so that he or she may examine and test the patient and acquire the clinical history. Even when an outside or remote expert does consult on a patient case, communication between the various clinicians is often incomplete, slow, and inefficient.

Frequently, the consultant has insufficient information, resulting in redundant testing and questioning of the patient, as well as risking omission of relevant clinical history. For example, the consultant may report back with a brief report that is mailed or faxed to one provider. Other members of the care team may not have access to this document. This traditional process does not facilitate an open exchange of questions and information or an ongoing collaboration, which can create inconvenience, increase costs, and adversely affect patient care and treatment.

For example, a child with developmental problems can exhibit multiple disorders, requiring treatment by several specialists in addition to a primary care physician. The disorders may be caused, or contributed to, by an underlying genetic variation. This relationship could be uncovered by a “genetic consult” with a geneticist, but due to the new and rapidly developing understanding of genetic influence on phenotypic expression, the treating physicians may or may not be aware of an expert who can link these disorders to a gene. If a genetic consult occurs, the geneticist will evaluate the child's exome, assessing all variants in relation to the patient's known biologic characteristics. This requires access to deep and extensive clinical history, information that is difficult to transmit with a referral request, or to elicit from the patient. The primary geneticist hopes to discover a possible link between a genetic variation and a biologic pathway that correlates with the patient history.

If one or more candidate explanatory variants are found, the primary geneticist might further extend the web of consultants. The geneticist may search out and engage researchers with expertise in one or more of the specific variants or pathways found in the patient case. A researcher might collaborate by using or creating a transgenic mouse model to replicate a feature of the patient's genotype. This mouse model can be used in laboratory evaluation of the effect of the gene feature on a mammalian biologic pathway. Once the biologic pathway is understood, the team might seek out researchers with expertise in the target biologic pathway to understand therapeutic options. They may try to locate researchers engaged in clinical trials focused on the target biologic pathway. These collaborators might propose or deliver therapies that affect the various disorders being treated by the original, primary clinical team. Throughout this process, the care team is challenged: to find an expert with knowledge most relevant to the patient's unique case, to engage that expert (usually across barriers of different healthcare institutions, and different geographic regions), to share clinical history, to communicate and exchange information through the progression of the diagnostic and therapeutic process.

Embodiments of the present disclosure relate to systems, methods, and user interfaces that enable consultations between clinicians. More particularly, embodiments of the present disclosure facilitate building threaded consultations with experts for an issue corresponding to a clinical concern. To do so, loosely-structured or unstructured threaded conversations are captured from at least one clinician. Based on a semantic analysis of the loosely-structured or unstructured threaded conversations from at least one clinician, an issue is identified. At least one virtual consultant is identified. Upon at least one virtual consultant accepting an invitation to collaborate on the issue, at least one virtual consultant is provided the loosely-structured or unstructured threaded conversations from at least one clinician. At least one virtual consultant is further enabled to add contributions to the issue.

In embodiments, automatic summarization and suggestion of potential issues are based on imported data and can be utilized to assist clinicians in selecting the appropriate issue or identifying the appropriate experts for consultations. Each issue may include associated expectations or commentary. In some embodiments, the expectations or commentary may be automatically provided based on a sematic analysis of the loosely-structured or unstructured threaded conversations or from an electronic medical record of the patient.

In this way, the most appropriate and cost-effective clinicians are able to provide consultations for the patient. Communications between all treating clinicians are improved. Consequently, increased quality of care, increased quality of life, and decreased cost of healthcare are provided.

Accordingly, in one aspect, an embodiment is directed to a system in a healthcare computing environment that creates a virtual consult record. The system comprises a processor; and a non-transitory computer storage medium storing computer-useable instructions that, when used by the processor, cause the processor to: capture loosely-structured or unstructured threaded conversations from at least one clinician; based on a semantic analysis of the loosely-structured or unstructured threaded conversations from the at least one clinician, identify an issue; and identify at least one virtual consultant to consult with for the issue.

In another aspect of the invention, an embodiment is directed to one or more computer storage media having computer-executable instructions embodied thereon, that when executed, perform a method for creating a virtual consult record. The method comprises semantically analyzing loosely-structured or unstructured threaded conversations from at least one clinician. The method also comprises, based on the analyzing, identifying an issue corresponding to the loosely-structured or unstructured threaded conversations. The method further comprises identifying at least one virtual consultant. The at least one virtual consultant comprises an expert in a clinical expert network for the issue. The method also comprises providing an invitation to the at least one virtual consultant to collaborate on the issue. The method further comprises receiving an acceptance to the invitation from the at least one virtual consultant. The method also comprises, upon receiving the acceptance, enabling the at least one virtual consultant to add contributions to the issue, the contributions being semantically analyzed to update the issue.

In a further aspect, an embodiment of the present invention is directed to one or more computer storage media having computer-executable instructions embodied thereon, that when executed, perform a method of creating a virtual consult record. The method comprises capturing loosely-structured or unstructured threaded conversations from at least one clinician. The method also comprises, based on a semantic analysis of the loosely-structured or unstructured threaded conversations from the at least one clinician, identifying an issue. The method further comprises identifying at least one virtual consultant remote from the at least one clinician. The method also comprises, upon the at least one virtual consultant accepting an invitation to collaborate on the issue, providing the at least one virtual consultant the loosely-structured or unstructured threaded conversations from the at least one clinician and enabling the at least one virtual consultant to add contributions to the issue.

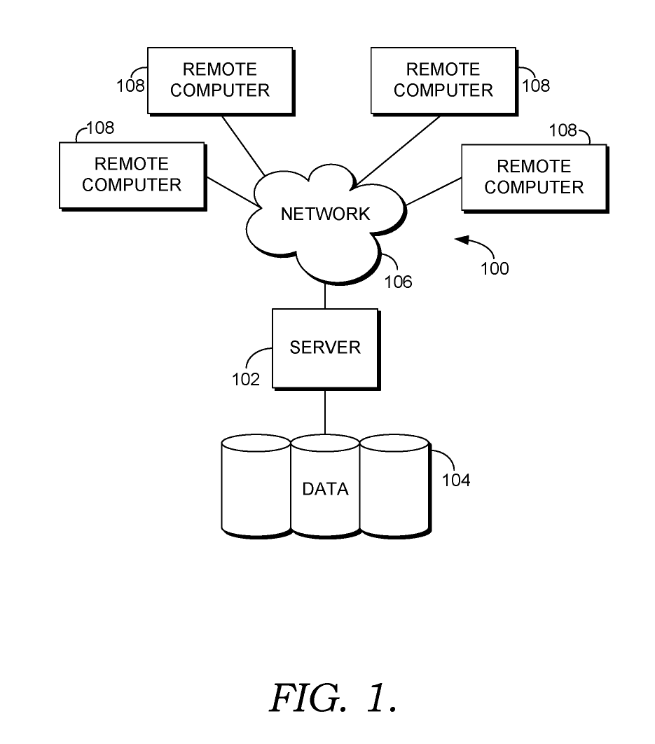

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other computing system environments or configurations. Examples of well-known computing systems, environments, and/or configurations that might be suitable for use with the present invention include personal computers, server computers, hand-held or laptop devices, wearable devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, ambulatory settings, medical billing and financial offices, hospital administration settings, home healthcare environments, clinicians' offices, Center for Disease Control, Centers for Medicare & Medicaid Services, World Health Organization, any governing body either foreign or domestic, Health Information Exchange, and any healthcare/government regulatory bodies not otherwise mentioned. Clinicians may comprise a treating physician or physicians; specialists such as intensivists, surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

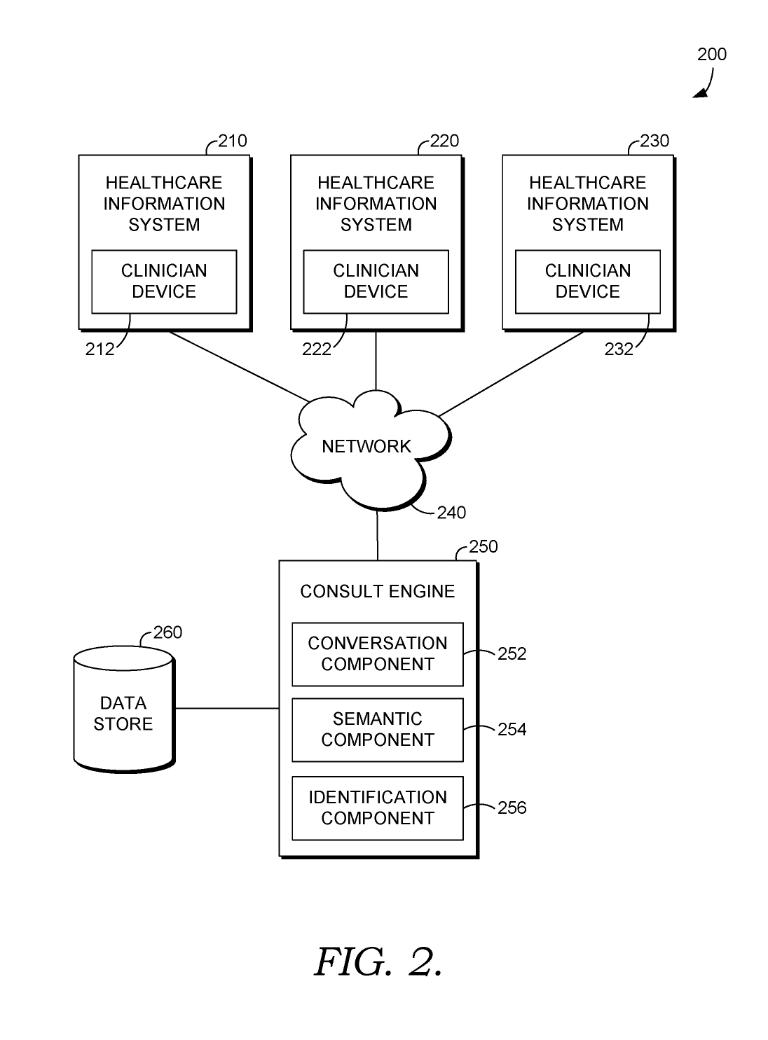

Turning now to FIG. 2, an exemplary computing system environment 200 is depicted suitable for use in implementing embodiments of the present invention. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes clinician device(s) 212, 222, 232 and a consult engine 250, all in communication with one another via a network 220. As illustrated, each of the clinician devices 212, 222, 232 may be remote from each other and part of different healthcare information systems 210, 220, 230. In some embodiments, the consult engine 250 comprises a conversation component 252, a semantic component 254, an identification component 256, and a data store 260.

The network 240 may include, without limitation, one or more secure local area networks (LANs) or wide area networks (WANs). The network 240 may be a secure network associated with a facility such as a healthcare facility. The secure network may require that a user log in and be authenticated in order to send and/or receive information over the network.

In some embodiments, one or more of the illustrated components/modules may be implemented as stand-alone applications. In other embodiments, one or more of the illustrated components/modules may be distributed across multiple consult engines. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the consult engine 250 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

Each of the healthcare information systems 210, 220, 230 is configured to provide information to and store information communicated by, for example, the consult engine 250 via the respective clinician devices 212, 222, 232. The information stored in association with the healthcare information systems 210, 220, 230 may comprise information received from or used by various components of the consult engine 250. As illustrated in FIG. 2, it is contemplated that multiple healthcare information systems 210, 220, 230 and multiple clinician devices 212, 222, 232 may be utilized by the present invention. In this way, data (e.g., loosely-structured or unstructured threaded conversations) may be aggregated from multiple sources (e.g., healthcare information systems) or multiple locations that are remote from each other and may be part of distinct and separate healthcare institutions.

In addition to including data e.g., loosely-structured or unstructured threaded conversations) provided by clinician devices 212, 222, 232, each of the healthcare information systems 210, 220, 230 may include information corresponding to patients associated with one or more healthcare facilities. The information may comprise electronic clinical documents such as images, clinical notes, orders, summaries, reports, analyses, information received from the consult engine 250 and medical devices (not shown in FIG. 2), or other types of electronic medical documentation relevant to a particular patient's condition and/or treatment.

Electronic clinical documents contain various types of information relevant to the condition and/or treatment of a particular patient and can include information relating to, for example, patient identification information, images, alert history, culture results, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, clinician assignments, and a host of other relevant clinical information.

The content and volume of such information in the healthcare information systems 210, 220, 230 is not intended to limit the scope of embodiments of the present invention in any way. Further, though each healthcare information systems 210, 220, 230 is illustrated as a single, independent component, the healthcare information systems 210, 220, 230 may, in fact, include a plurality of applications and/or storage devices, for instance, a database cluster.

The clinician devices 212, 222, 232 may be any type of computing device capable of communicating with the consult engine 250 or healthcare information systems 210, 220, 230 to interact with information and/or data as described herein. Such devices may include any type of mobile and portable devices including cellular telephones, personal digital assistants, tablet PCs, smart phones, and the like.

Consult engine 250 may include a processing unit, internal system memory, and a suitable system bus for coupling various system components, including one or more data stores for storing information (e.g., files and metadata associated therewith). The consult engine 250 typically includes, or has access to, a variety of computer-readable media.

The computing system environment 200 is merely exemplary. While the consult engine 250 is illustrated as a single unit, it will be appreciated that the consult engine 250 is scalable. For example, the consult engine 250 may in actuality include a plurality of computing devices in communication with one another. The single unit depictions are meant for clarity, not to limit the scope of embodiments in any form.

As described above, consult engine 250 includes conversation component 252, semantic component 254, and identification component 256. While these components are included in the embodiment of FIG. 2, any number of components, either more or less than the illustrated components, may be used to accomplish the purposes of the present invention. Other components and subcomponents are contemplated to be within the scope of the present invention. Furthermore, although depicted as residing on one device, such as a server, it will be appreciated that any number of components and/or subcomponents may reside on any number of computing devices or servers.

Conversation component 252 is generally configured to capture loosely-structured or unstructured threaded conversations from at least one clinician. A contribution to the conversation may be textual, captured from typing, voice recognition or other methods. The contribution may include or consist of multi-media elements including images, screen shots, graphics, or reports. Data may also communicated from the healthcare information system 210, 220, 230 via the clinician device 212, 222, 232. For example, the clinician using the conversation component may identify data from the healthcare information system to include in the conversation, such as laboratory results, reports, or images. Contributions to the conversation may be in Internet data formats such as plain text, formatted text, image, video or tables. Contributions can also include clinical data exchange formats, such as an HL7 CDA® document.

Semantic component 254 is generally figured to semantically analyze the data or information captured by conversation component 252. Natural language processing identifies clinical concepts represented by keywords in the loosely-structured or unstructured threaded conversations, while rules are applied to structured data. The conversations may be indexed by the results of semantic analysis, to facilitate identifying the issue.

Clinical findings appearing in the data or information may trigger the identification of a particular clinical concern. The association of clinical concepts and data elements to a concern is based on a set of mappings and rules. Additionally or alternatively, machine-learning techniques may be employed to determine when a particular concern should be identified. In various embodiments, the concerns include a genetic research hypothesis, a radiology issue, a neurology issue, a pharmaceutical issue, a cardiac issue, or a disease related issue. From each clinical concern, the system may generate one or more “issues” having the clinical concern or a related problem as its subject. The issue provides a means for clinicians to track and collaborate on a clinical concern. Various keywords appearing in the data or information may trigger the identification of or be mapped to a particular issue. Additionally or alternatively, machine-learning techniques may be employed to determine when a particular issue should be identified. Based on a semantic analysis of the loosely-structured or unstructured threaded conversations from at least one clinician, an issue is identified.

Identification component 256 identifies at least one virtual consultant to consult with for the issue. At least one virtual consultant is an expert in a clinical expert network for the issue. An invitation may be provided by the identification component 256 to at least one virtual consultant to collaborate on the issue. The invitation may comprise a queue of issues that at least one virtual consultant is qualified to address. The identification component 256 may additionally receive an acceptance to the invitation from at least one virtual consultant.

Upon receiving the acceptance, the identification component 256 may enable at least one virtual consultant to add contributions to the issue. Additionally or alternatively, upon receiving the acceptance, the conversation component 252 may provide at least one virtual consultant the loosely-structured or unstructured threaded conversations from at least one clinician.

Data store 260 generally stores data for each component of the consult engine 250. For example, the data store 260 may store conversations or issues, enabling collaboration and contributions for persisted conversations or issues. Additionally, data store 260 may include a semantic index that facilitates identifying relationships between persisted conversations or issues.

In embodiments, contributions received from at least one virtual consultant are captured by the conversation component 252. Accordingly, the semantic component 254 may update the issue (or identify additional issues) corresponding to the contributions received from at least one virtual consultant. Additionally or alternatively, upon receiving the contributions, the conversation component 252 may enable at least one virtual consultant to close the issue.

In embodiments, the issue comprises expectations and commentary. Such expectations and commentary may be communicated to the virtual consultant. The expectations and commentary may prompt the virtual consultant to add contributions that are needed from an expert for the issue in order to close the issue.

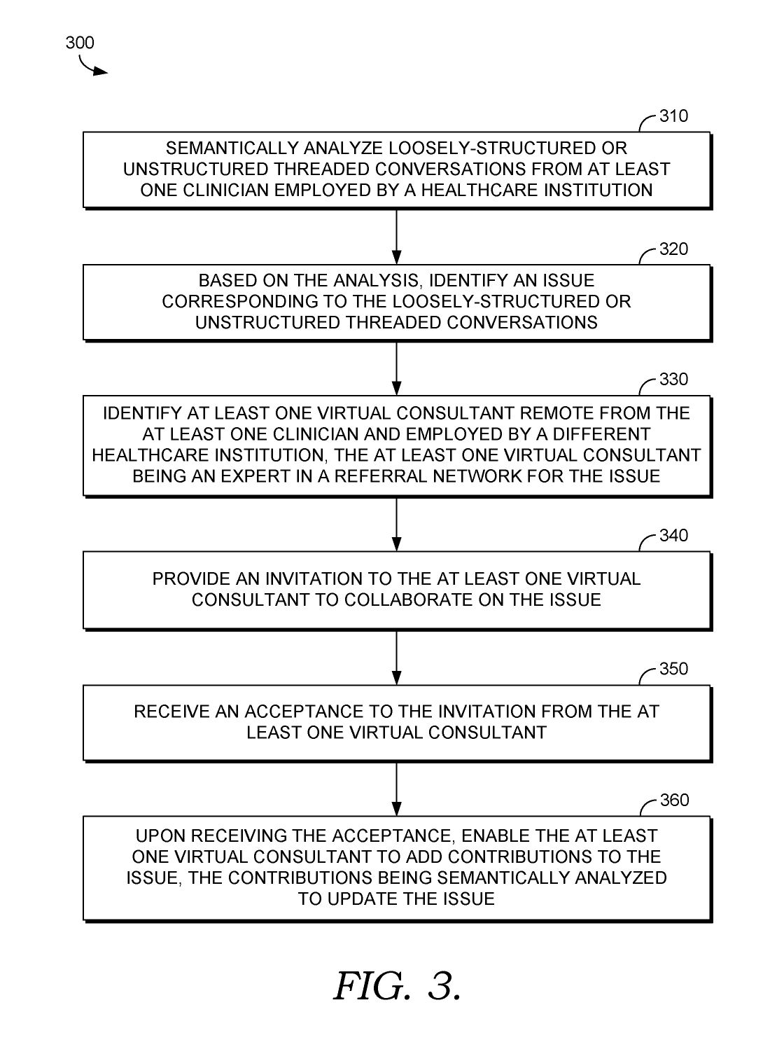

Turning now to FIG. 3, a flow diagram is provided illustrating a method 300 of identifying a virtual consultant to collaborate with for a particular issue, in accordance with an embodiment of the present invention. Initially, as shown at step 310, loosely-structured or unstructured threaded conversations from at least one clinician is semantically analyzed, such as by using by consult engine 230 of FIG. 2.

At step 320, based on the analyzing, an issue corresponding to a clinical concern found in the loosely-structured or unstructured threaded conversations is identified. The issue may comprise expectations and commentary. In some embodiments, the loosely-structured or unstructured threaded conversations are indexed to facilitate identifying the issue.

At step 330, at least one virtual consultant is identified. At least one virtual consultant is an expert in a clinical expert network for the issue. In some embodiments, at least one virtual consultant is remote from the at least one clinician. In some embodiments, at least one virtual consultant may be employed by a different healthcare institution than at least one clinician.

At step 340, an invitation to at least one virtual consultant to collaborate on the issue is provided. The invitation may comprise a queue of issues that at least one virtual consultant is qualified to address. In various embodiments, the subjects of the issues include a genetic research hypothesis, a radiology issue, a neurology issue, a pharmaceutical issue, a cardiac issue, or a disease related issue.

At step 350, an acceptance to the invitation from at least one virtual consultant is received.

At step 360, upon receiving the acceptance, at least one virtual consultant is enabled to add contributions to the issue. At least one virtual consultant may also be provided the loosely-structured or unstructured threaded conversations from at least one clinician. In some embodiments, contributions are received from at least one virtual consultant. The contributions may be captured and semantically analyzed, such as by using by consult engine 230 of FIG. 2. The issue may be further updated corresponding to the contributions received from at least one virtual consultant.

In some embodiments, upon receiving the contributions, at least one virtual consultant is enabled to close the issue.

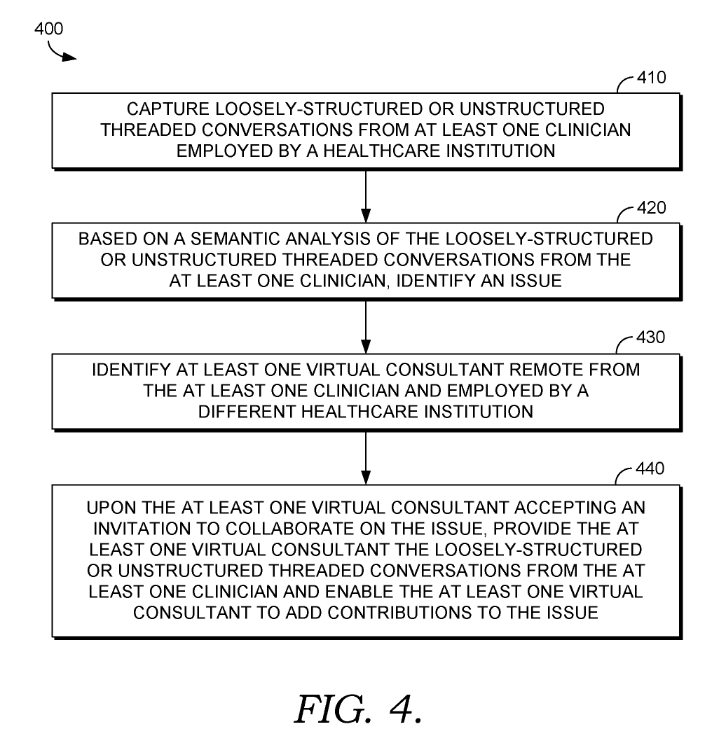

Turning now to FIG. 4, a flow diagram is provided illustrating a method 400 of identifying a virtual consultant to collaborate with for a particular issue, in accordance with an embodiment of the present invention. Initially, as shown at step 410, loosely-structured or unstructured threaded conversations from at least one clinician are captured, such as by using by consult engine 230 of FIG. 2.

At step 420, based on a semantic analysis of the loosely-structured or unstructured threaded conversations from at least one clinician, an issue is identified.

At step 430, at least one virtual consultant remote from at least one clinician is identified.

At step 440, upon at least one virtual consultant accepting an invitation to collaborate on the issue, at least one virtual consultant is provided the loosely-structured or unstructured threaded conversations from at least one clinician. Additionally, at least one virtual consultant is enabled to add contributions to the issue.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described. Accordingly, the scope of the invention is intended to be limited only by the following claims.

What is claimed is:

1. A system for creating a virtual consult record, the system comprising:
a processor; and a non-transitory computer storage medium storing computer-useable instructions that, when used by the processor, cause the processor to:
(a) capture loosely-structured or unstructured threaded conversations from at least one clinician;
(b) based on a semantic analysis of the loosely-structured or unstructured threaded conversations from the at least one clinician, identify an issue; and
(c) identify at least one virtual consultant to consult with for the issue.

2. The system of claim 1, further comprising receiving contributions from the at least one virtual consultant.

3. The system of claim 2, further updating the issue corresponding to the contributions received from the at least one virtual consultant.

4. The system of claim 1, wherein the issue comprises expectations and commentary.

5. The system of claim 1, further comprising indexing the loosely-structured or unstructured threaded conversations to facilitate identifying the issue.

6. The system of claim 1, wherein the at least one virtual consultant is an expert in a clinical expert network for the issue.

7. The system of claim 1, further comprising providing an invitation to the at least one virtual consultant to collaborate on the issue.

8. The system of claim 7, further comprising receiving an acceptance to the invitation from the at least one virtual consultant.

9. The system of claim 8, further comprising, upon receiving the acceptance, enabling the at least one virtual consultant to add contributions to the issue.

10. The system of claim 8, further comprising, upon receiving the acceptance, providing the at least one virtual consultant the loosely-structured or unstructured threaded conversations from the at least one clinician.

11. The system of claim 9, further comprising, upon receiving the contributions, enabling the at least one virtual consultant to close the issue.

12. The system of claim 7, wherein the invitation comprises a queue of issues that the at least one virtual consultant is qualified to address.

13. The system of claim 1, wherein the issue is a genetic research hypothesis.

14. The system of claim 1, wherein the issue is a radiology issue.

15. The system of claim 1, wherein the issue is a neurology issue.

16. The system of claim 1, wherein the issue is a pharmaceutical issue.

17. The system of claim 1, wherein the issue is a cardiac issue.

18. The system of claim 1, wherein the issue is a disease related issue.

19. A computerized method for creating a virtual consult record, the method comprising:
semantically analyzing loosely-structured or unstructured threaded conversations from at least one clinician;
based on the analyzing, identifying an issue corresponding to the loosely-structured or unstructured threaded conversations;
identifying at least one virtual consultant, the at least one virtual consultant being an expert in a clinical expert network for the issue;
providing an invitation to the at least one virtual consultant to collaborate on the issue;
receiving an acceptance to the invitation from the at least one virtual consultant; and
upon receiving the acceptance, enabling the at least one virtual consultant to add contributions to the issue, the contributions being semantically analyzed to update the issue.

20. One or more computer storage media having computer-executable instructions embodied thereon that, when executed, facilitate a method of creating a virtual consult record, the method comprising:
capturing loosely-structured or unstructured threaded conversations from at least one clinician;
based on a semantic analysis of the loosely-structured or unstructured
identifying at least one virtual consultant remote from the at least one clinician;
upon the at least one virtual consultant accepting an invitation to collaborate on the issue, providing the at least one virtual consultant the loosely-structured or unstructured threaded conversations from the at least one clinician and enabling the at least one virtual consultant to add contributions to the issue.
